(19) United States
(12) Patent Application Publication
(10) Pub. No.: US 2026/0084187 A1
(43) Pub. Date: Mar. 26, 2026

(54) SUBSTRATE TREATING METHOD AND SUBSTRATE TREATING APPARATUS

(71) Applicant: SEMES CO., LTD., Cheonan-si (KR)

(72) Inventors: Kang Sul KIM, Hwaseong-si (KR); Tae Keun KIM, Siheung-si (KR); Jun Hee CHOI, Yongin-si (KR); Kyeong Min LEE, Hwaseong-si (KR); Yong Jun KIM, Suwon-si (KR)

(73) Assignee: SEMES CO., LTD., Cheonan-si (KR)

(21) Appl. No.: 19/335,720

(22) Filed: Sep. 22, 2025

(30) Foreign Application Priority Data
Sep. 20, 2024 (KR) 10-2024-0127474

(51) Int. Cl. B08B 1/52

(52) U.S. Cl. CPC B08B 1/52

(57) ABSTRACT

Provided are a substrate treating method and a substrate treating apparatus. The substrate treating method includes: a treating operation of discharging a treatment liquid onto a substrate through a nozzle and treating the substrate with the treatment liquid; a moving operation of stopping the discharge of the treatment liquid and moving the nozzle to a homeport where the nozzle waits; a cleaning operation of cleaning the nozzle with a cleaning liquid in the homeport; and a discharging operation of discharging the treatment liquid from the nozzle into the homeport. Accordingly, it is possible to efficiently remove foreign substances remaining on a surface and the inside of the nozzle.

### CROSS-REFERENCE TO RELATED APPLICATION

This application claims priority to and the benefit of Korean Patent Application No. 10-2024-0127474 filed in the Korean Intellectual Property Office on Sep. 20, 2024, the entire contents of which are incorporated herein by reference.

### TECHNICAL FIELD

The present invention relates to a substrate treating method and a substrate treating apparatus, and more specifically, to a substrate treating method and a substrate treating apparatus that liquid-treat a substrate by supplying a liquid to the substrate.

### BACKGROUND ART

In order to manufacture a semiconductor device, various processes, such as photographing, deposition, etching, and ion implantation, are performed. Further, before and after the processes are performed, a cleaning process for cleaning foreign substances remaining on a substrate is performed.

Recently, in the cleaning process, a method of supplying a treatment liquid containing polymer materials and solvents onto a substrate, solidifying or curing the treatment liquid while volatilizing the solvent and capturing foreign substances present on the substrate, and removing the foreign substances on the substrate by stripping a treatment film, which is a solidified or cured treatment liquid, has been used.

When the cleaning process is completed, the nozzle is moved to a homeport and waits. The nozzle may be in a state in which a treatment liquid remains on the surface and inside thereof. In this case, when the volatility of the solvent is high, the solvent is volatilized and the treatment liquid is solidified.

In order to clean the solidified treatment liquid, the cleaning liquid is sprayed from the homeport toward the nozzle. Thereby, although the surface of the nozzle is cleaned, it is difficult to directly spray the cleaning liquid into the nozzle, so it is difficult to clean the solidified treatment liquid present inside the nozzle. This causes foreign substances in the subsequent process and causes a problem that makes it difficult to uniformly spray the treatment liquid.

In order to prevent curing of the treatment liquid inside the nozzle, a method of forming a blocking layer that intentionally blocks contact between the treatment liquid and air, and the like are used. However, this method requires additional processes and configurations, causing problems, such as increased device complexity, technical difficulty, time, and cost.

### SUMMARY OF THE INVENTION

The present invention has been made in an effort to provide a substrate treating method and a substrate treating apparatus capable of efficiently removing foreign substances remaining on a surface and an inside of a nozzle.

The present invention has also been made in an effort to provide a substrate treating method and a substrate treating apparatus capable of improving process stability by uniformly discharging a treatment liquid from a nozzle.

The objectives of the present disclosure are not limited thereto and other objectives not stated herein may be clearly understood by those skilled in the art from the following description.

An exemplary embodiment of the present disclosure, a method of treating a substrate, the method may comprising, a treating operation of discharging a treatment liquid onto a substrate through a nozzle and treating the substrate with the treatment liquid; a moving operation of stopping the discharge of the treatment liquid and moving the nozzle to a homeport where the nozzle waits; a cleaning operation of cleaning the nozzle with a cleaning liquid in the homeport; and a discharging operation of discharging the treatment liquid from the nozzle into the homeport.

According to the exemplary embodiment of the present invention, wherein the treatment liquid includes a polymer and a solvent, and in the cleaning operation, the treatment liquid that has been solidified by volatilization of the solvent in the treatment liquid remaining in the nozzle may be dissolved in vapor of the cleaning liquid.

According to the exemplary embodiment of the present invention, wherein the cleaning operation and the discharging operation may be repeatedly performed at preset intervals.

According to the exemplary embodiment of the present invention, wherein in the cleaning operation, the cleaning liquid may be sprayed toward an outer surface of the nozzle.

According to the exemplary embodiment of the present invention, wherein in the cleaning operation, the nozzle may be immersed in the cleaning liquid filled in the homeport.

According to the exemplary embodiment of the present invention, wherein the cleaning operation may includes cleaning the nozzle with the heated cleaning liquid.

According to the exemplary embodiment of the present invention, wherein the discharging operation may be performed after a set time has elapsed after the cleaning operation.

According to the exemplary embodiment of the present invention, wherein the cleaning liquid may be the solvent.

According to the exemplary embodiment of the present invention, wherein the cleaning liquid may be isopropyl alcohol (IPA).

According to the exemplary embodiment of the present invention, wherein the discharging operation may includes discharging the treatment liquid in the nozzle by discharging a discharge medium.

According to the exemplary embodiment of the present invention, wherein the discharge medium may be in a liquid or gaseous state.

According to the exemplary embodiment of the present invention, wherein the treatment liquid is a first treatment liquid or a second treatment liquid, and the treating operation may includes: a treatment film forming operation of forming a treatment film by supplying the first treatment liquid to the substrate; and a removing operation of removing the treatment film from the substrate by supplying the second treatment liquid to the substrate.

An exemplary embodiment of the present disclosure, an apparatus for treating a substrate, the apparatus comprising: a support unit for supporting a substrate; a treating container surrounding an outer side of the support unit; a treatment liquid supply unit for supplying a treatment liquid that treats the substrate; a nozzle unit including a nozzle that supplies the treatment liquid to a substrate supported by the support unit; a homeport where the nozzle waits; and a controller for controlling the support unit, the nozzle unit, the treatment liquid supply unit, and the homeport, wherein the homeport includes: a housing providing a space therein; a cleaning liquid supply unit including a cleaning liquid nozzle that sprays the cleaning liquid toward the nozzle located in the housing; and a drainage unit for discharging the cleaning liquid supplied from the cleaning liquid supply unit, and the controller controls to perform: a treating operation of treating the substrate by discharging the treatment liquid onto the substrate supported by the support unit through the nozzle; a moving operation of stopping the discharge of the treatment liquid and moving the nozzle to the homeport where the nozzle waits; a cleaning operation of cleaning the nozzle with a cleaning liquid in the homeport; and a discharging operation of discharging the treatment liquid from the nozzle into the homeport.

According to the exemplary embodiment of the present invention, wherein the treatment liquid includes a polymer and a solvent, and the cleaning liquid supply unit includes a heater that heats the cleaning liquid, and the controller may controls to, in the cleaning operation, heat the cleaning liquid, spray the heated cleaning liquid to the nozzle, and dissolve the treatment liquid that has been solidified by volatilization of the solvent in the treatment liquid remaining in the nozzle in vapor of the cleaning liquid.

According to the exemplary embodiment of the present invention, wherein the drainage unit includes: a drainage line connected to a drainage port formed on a bottom of the housing; and a drainage valve installed in the drainage line, and the controller may controls to, in the cleaning operation, fill an interior of the housing with the cleaning liquid and immerse the nozzle with the cleaning liquid.

According to the exemplary embodiment of the present invention, wherein the cleaning liquid may be the solvent.

According to the exemplary embodiment of the present invention, wherein the treatment liquid supply unit further includes a discharge medium supply source that supplies a discharge medium, and the controller may controls to discharge the discharge medium in the discharging operation.

An exemplary embodiment of the present disclosure, a method of treating a substrate, the method comprising: a treating operation of discharging a treatment liquid onto a substrate through a nozzle and treating the substrate; a moving operation of stopping the discharge of the treatment liquid and moving the nozzle to the homeport where the nozzle waits; a cleaning operation of cleaning the nozzle with a cleaning liquid in the homeport; and a discharging operation of discharging the discharge medium from the nozzle, wherein the treatment liquid includes a polymer and a solvent, and the cleaning liquid is the solvent, the homeport includes: a housing providing a space therein; a cleaning liquid supply unit including a cleaning liquid nozzle that sprays the cleaning liquid toward the nozzle located in the homeport and a heater that heats the cleaning liquid; and a drainage unit for discharging the cleaning liquid supplied from the cleaning liquid supply unit, and the cleaning operation includes spraying the heated cleaning liquid toward a surface of the nozzle after the solvent in the treatment liquid remaining in the nozzle volatilizes and the treatment liquid is cured, and the discharging operation includes dissolving the treatment liquid that has been cured inside the nozzle by vapor generated from the cleaning liquid, and then discharging the discharge medium to remove the discharge medium from an inside of the nozzle.

According to the exemplary embodiment of the present invention, wherein the cleaning operation may includes filling the homeport with the cleaning liquid and immersing the nozzle in the cleaning liquid.

According to the exemplary embodiment of the present invention, wherein the treatment liquid is a first treatment liquid or a second treatment liquid, and the treating operation may includes, a treatment film forming operation of supplying the first treatment liquid to the substrate to form a treatment film; and a removing operation of removing the treatment film from the substrate by supplying the second treatment liquid to the substrate.

According to the exemplary embodiment of the present invention, it is possible to efficiently remove foreign substances remaining on the surface and the inside of the nozzle.

In addition, according to the present invention, it is possible to improve process stability by uniformly discharging the treatment liquid from the nozzle.

Effects of the present disclosure are not limited to those described above and effects not stated above will be clearly understood to those skilled in the art from the specification and the accompanying drawings.

### BRIEF DESCRIPTION OF THE DRAWINGS

The various features and advantages of the non-limiting exemplary embodiment of the present specification may become more apparent by reviewing the detailed description together with the accompanying drawings. The accompanying drawings are provided for illustrative purposes only and should not be construed as limiting the scope of claims. The accompanying drawings are not considered to be drawn to scale unless explicitly stated. For clarity, the various dimensions of the drawings may have been exaggerated.

FIG. 1 is a top plan view schematically illustrating a substrate treating apparatus according to an exemplary embodiment of the present invention.

FIG. 2 is a diagram schematically illustrating a liquid treating chamber of FIG. 1 according to an exemplary embodiment.

FIG. 3 is a diagram schematically illustrating a homeport of FIG. 2 according to an exemplary embodiment.

FIG. 4 is a flowchart illustrating a substrate treating method according to an exemplary embodiment of the present invention.

FIG. 5 is a diagram schematically illustrating a state in a cleaning operation of FIG. 4.

FIG. 6 is a diagram schematically illustrating a discharging operation of FIG. 4 according to an exemplary embodiment.

FIG. 7 is a diagram schematically illustrating the cleaning operation of FIG. 5 according to another exemplary embodiment.

FIG. 8 is a diagram schematically illustrating a treatment liquid supply unit according to another exemplary embodiment.

FIG. 9 is a diagram schematically illustrating the cleaning operation of FIG. 4 according to still another exemplary embodiment.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range (e.g., ±10%).

When the terms “about” or “substantially” are used in connection with a numerical value, it should be understood that the associated numerical value includes a manufacturing or operational tolerance (e.g., ±10%) around the stated numerical value. Moreover, when the words “generally” and “substantially” are used in connection with a geometric shape, it should be understood that the precision of the geometric shape is not required but that latitude for the shape is within the scope of the disclosure.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

In the present exemplary embodiment, a wafer is described as an example as a target to be treated. However, the technical spirit of the present invention may be applied to apparatuses used for treating other types of substrates, other than wafers, as targets to be treated.

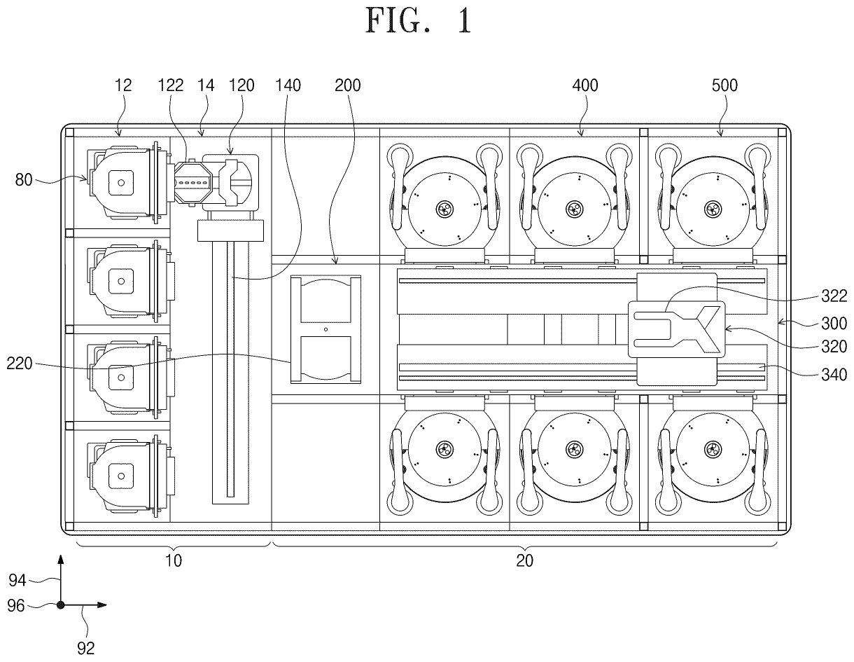

Hereinafter, an exemplary embodiment of the present invention will be described with reference to the accompanying drawings. FIG. 1 is a top plan view schematically illustrating a substrate treating apparatus according to an exemplary embodiment of the present invention.

Referring to FIG. 1, a substrate treating apparatus includes an index module 10 and a treating module 20. According to an example, the index module 10 and the treating module 20 are disposed along one direction. Hereinafter, the direction in which the index module 10 and the treating module 20 are disposed is referred to as a first direction 92, and when viewed from above, a direction perpendicular to the first direction 92 is referred to as a second direction 94, and a direction perpendicular to both the first direction 92 and the second direction 94 is referred to as a third direction 96.

The index module 10 transfers a substrate W from a container 80 in which the substrate W is accommodated to the treating module 20, and makes the substrate W, which has been completely treated in the treating module 20, be accommodated in the container 80. A longitudinal direction of the index module 10 is provided in the second direction 94. The index module 10 includes a load port 12 and an index frame 14. Based on the index frame 14, the load port 12 is located at a side opposite to the treating module 20. The containers 80 in which the substrates W are accommodated are placed on the load ports 12. The load port 12 may be provided in plurality, and the plurality of load ports 12 may be disposed in the second direction 94.

As the container 80, an airtight container, such as a Front Open Unified Pod (FOUP), may be used. The container 80 may be placed on the load port 12 by a transfer means (not illustrated), such as an overhead transfer, an overhead conveyor, or an automatic guided vehicle, or an operator.

An index robot 120 is provided to the index frame 14. A guide rail 140 of which a longitudinal direction is the second direction Y is provided within the index frame 14, and the index robot 120 may be provided to be movable on the guide rail 140. The indexing robot 120 includes a hand 122 on which the substrate W is placed, and the hand 122 may be provided to be movable forward and backward, rotatable about the third direction 96, and movable along the third direction 96. The plurality of hands 122 is provided while being spaced apart from each other in the vertical direction, and is capable of independently moving forward and backward.

The treating module 20 includes a buffer unit 200, a transfer chamber 300, and a liquid treating chamber 400. The buffer unit 200 provides a space in which the substrate W loaded into the treating module 20 and the substrate W unloaded from the treating module 20 stay temporarily. The liquid treating chamber 400 performs a treatment process of liquid treating the substrate W by supplying a liquid onto the substrate W. The transfer chamber 300 transfers the substrate W between the buffer unit 200 and the liquid treating chamber 400.

The transfer chamber 300 may be provided so that a longitudinal direction is the first direction 92. The buffer unit 200 may be disposed between the index module 10 and the transfer chamber 300. The liquid treating chamber 400 may be disposed on a side portion of the transfer chamber 300. The liquid treating chamber 400 and the transfer chamber 300 may be disposed in the second direction 94. The buffer unit 200 may be located at one end of the transfer chamber 300.

According to an example, the liquid treating chambers 400 may be disposed at opposite sides of the transfer chamber 300, and the liquid treating chambers 400 may be provided in an arrangement of A×B (where A and B are each 1 or a natural number equal to or greater than 1) at one side of the transfer chamber 300 along the first direction 92 and the third direction 96, respectively.

The transfer chamber 300 includes a transfer robot 320. A guide rail 340 having a longitudinal direction in the first direction 92 is provided in the transfer chamber 300, and the transfer robot 320 may be provided to be movable on the guide rail 340. The transfer robot 320 includes a hand 322 in which the substrate W is placed, and the hand 322 may be provided to be movable forwardly and backwardly, rotatable about the third direction 96, and movable along the third direction 96. The plurality of hands 322 is provided while being spaced apart from each other in the vertical direction, and is capable of independently moving forward and backward.

The buffer unit 200 includes a plurality of buffers 220 on which the substrate W is placed. The buffers 220 may be disposed while being spaced apart from each other in the third direction 96. A front face and a rear face of the buffer unit 200 are opened. The front face is a face facing the index module 10, and the rear face is a face facing the transfer unit 300. The index robot 120 may approach the buffer unit 200 through the front face, and the transfer robot 320 may approach the buffer unit 200 through the rear face.

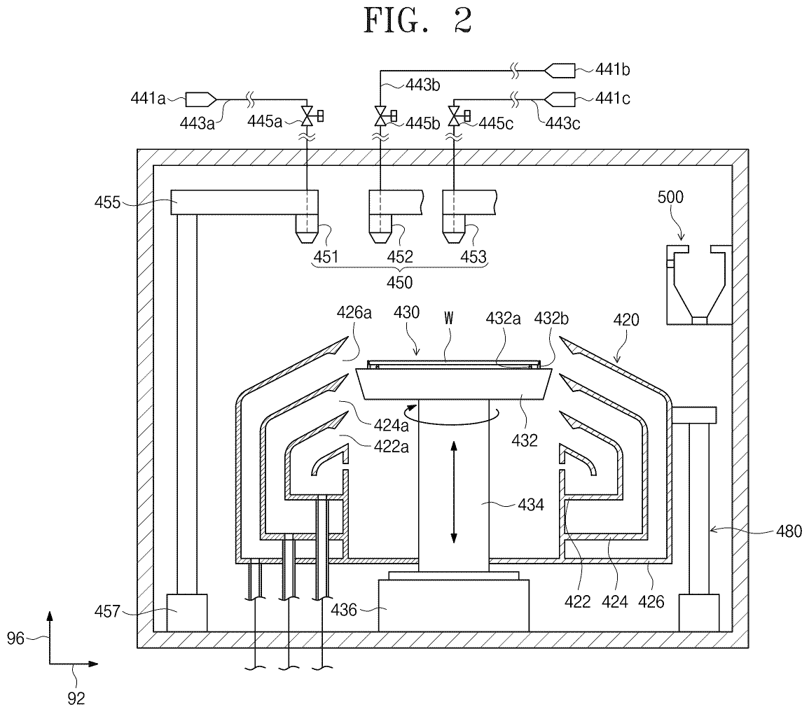

FIG. 2 is a diagram schematically illustrating the liquid treating chamber 400 of FIG. 1 according to the exemplary embodiment. Referring to FIG. 2, the liquid treating chamber 400 includes a housing 410, a cup 420, a support unit 430, a treatment liquid supply unit 440, a nozzle unit 450, a lifting unit 480, a homeport 500, and a controller 600.

The housing 410 is provided in a generally rectangular parallelepiped shape. The housing 410 provides space therein. An opening (not illustrated) through which the substrate W enters and exits is formed in the housing 410.

The cup 420 has a treatment space with an open top, and the substrate W is liquid-treated in the treatment space. The support unit 430 supports the substrate W in the treatment space. The treatment liquid supply unit 440 supplies the liquid onto the substrate W supported by the support unit 430. The liquid may be provided in a plurality of types, and may be sequentially supplied onto the substrate W. The lifting unit 480 adjusts a relative height between the cup 420 and the support unit 430.

According to an example, the cup 420 includes a plurality of recovery tanks 422, 424, and 426. Each of the recovery tanks 422, 424, and 426 has a recovery space for recovering the liquid used for the treatment of the substrate. Each of the recovery tanks 422, 424, and 426 is provided in a ring shape surrounding the support unit 430. As the liquid treating process proceeds, the treatment liquid scattered by the rotation of the substrate W is introduced into the recovery space through inlets 422a, 424a, and 426a of the respective recovery tanks 422, 424, and 426.

According to the example, the cup 420 includes a first recovery tank 422, a second recovery tank 424, and a third recovery tank 426. The first recovery tank 422 is disposed to surround the support unit 430, the second recovery tank 424 is disposed to surround the first recovery tank 422, and the third recovery tank 426 is disposed to surround the second recovery tank 424. The second inlet 424a through which the liquid flows into the second recovery tank 424 may be located above the first inlet 422a through which the liquid flows into the first recovery tank 422, and the third inlet 426a through which the liquid flows into the third recovery tank 426 may be located above the second inlet 424a.

The support unit 430 includes a support plate 432 and a drive shaft 434. An upper surface of the support plate 432 may be provided in a generally circular shape, and may have a diameter larger than a diameter of the substrate W. A support pin 432a for supporting a rear surface of the substrate W is provided at the center portion of the support plate 432, and an upper end of the support pin 432a protrudes from the support plate 432 such that the substrate W is spaced apart from the support plate 432 by a predetermined distance.

A chuck pin 432b is provided at an edge of the support plate 432. The chuck pin 432b is provided to protrude upward from the support plate 432, and supports a side portion of the substrate W so that the substrate W is not separated from the supporting unit 432 when the substrate W is rotated. The drive shaft 434 is driven by the driver 436, is connected to a center of a bottom surface of the substrate W, and rotates the support plate 432 with respect to its central axis.

The treatment liquid supply unit 440 supplies the treatment liquid to the nozzle unit 450. The treatment liquid may be a first treatment liquid, a second treatment liquid, or a third treatment liquid. The treatment liquid supply unit 440 may include a first treatment liquid supply source 441a, a second treatment liquid supply source 441b, and a third treatment liquid supply source 441c.

The first treatment liquid supply source 441a stores and supplies the first treatment liquid. The first treatment liquid supply source 441a may be connected to the first nozzle 451 by a first treatment liquid supply line 443a. The first treatment liquid may be a mixed liquid of a polymer and a solvent. The first treatment liquid is supplied onto the substrate W and then contracts as the solvent volatilizes, thereby forming a solidified treatment film. Foreign substances on the substrate W are captured while the treatment film is formed. According to an example, a polymer includes a resin. The resin may be an acrylic resin, a phenol resin, an epoxy resin, a melanin resin, a urea resin, an unsaturated polyester resin, an alkid resin, a polyurethane resin, a polyimide resin, a polyethylene resin, a polypropylene resin, a polyvinyl chloride resin, a polystyrene resin, a polyimide resin, a vinyl resin, or another resin. Also, the solvent may be an organic solvent. Also, the solvent may be an isopropyl alcohol (IPA), butanol, or methyl isobutyl carbonol (MIBC).

The second treatment liquid supply source 441b stores and supplies the second treatment liquid. The second treatment liquid supply source 441b may be connected to the second nozzle 452 by a second treatment liquid supply line 443b. The second treatment liquid may be a stripping liquid. After the second treatment liquid is supplied onto the substrate W, the second treatment liquid may penetrate into a boundary surface between the treatment film and the substrate W to strip the treatment film from the substrate W. In this case, particles captured in the treatment film are also stripped off together with the treatment film. According to an example, the second treatment liquid may be deionized water.

The third treatment liquid supply source 441c stores and supplies the third treatment liquid. The third treatment liquid supply source 441c may be connected to the third nozzle 453 by the third treatment liquid supply line 443c. The third treatment liquid may be a dissolution liquid. After the third treatment liquid is supplied onto the substrate W, a residue of the treatment film stripped off on the substrate W is removed from the substrate W. The dissolution liquid may be an organic solvent. According to an example, the organic solvent may be IPA.

A chuck-back valve 445a may be provided in the first treatment liquid supply line 443a. When the discharge of the first treatment liquid from the first nozzle 451 is terminated, the suck-back valve sucks back the first treatment liquid to prevent the first treatment liquid remaining in a flow path 451a formed in the first nozzle from dropping. The second treatment liquid supply line 443b and the third treatment liquid supply line 443c are also provided with a second suck-back valve 445b and a third suck-back valve 445c, respectively. A description thereof is the same as that of the first suck-back valve 445a, and thus will be omitted.

The nozzle unit 450 includes a first nozzle 451, a second nozzle 452, a third nozzle 453, an arm 455, and a driving unit 457. Flow paths 451a, 451b, and 451c through which the first treatment liquid, the second treatment liquid, and the third treatment liquid flow are formed in the first nozzle 451, the second nozzle 452, and the third nozzle 453, respectively. The first nozzle 451, the second nozzle 452, and the third nozzle 453 each supply the first to third treatment liquids onto the substrate W. The first nozzle 451, the second nozzle 452, and the third nozzle 453 are supported by the arm 455. The first nozzle 451, the second nozzle 452, and the third nozzle 453 are supported by different arms 455, respectively, and these arms 455 may move independently. The arm 455 may be driven by the driving unit 457. The arm 455 may move the first nozzle 451, the second nozzle 452, and the third nozzle 453. The driving unit 457 may be provided so that the arm 455 rotates or vertically moves.

The lifting unit 480 moves the cup 420 in the up and down direction. By the up and down movement of the cup 420, a relative height between the cup 420 and the substrate W is changed. Accordingly, the recovery tanks 422, 424, and 426 for recovering the treatment liquid are changed according to the type of liquid supplied to the substrate W, and thus the liquids may be separated and recovered. Unlike the description, the cup 420 may be fixedly installed, and the lifting unit 480 may move the support unit 440 in the up and down direction.

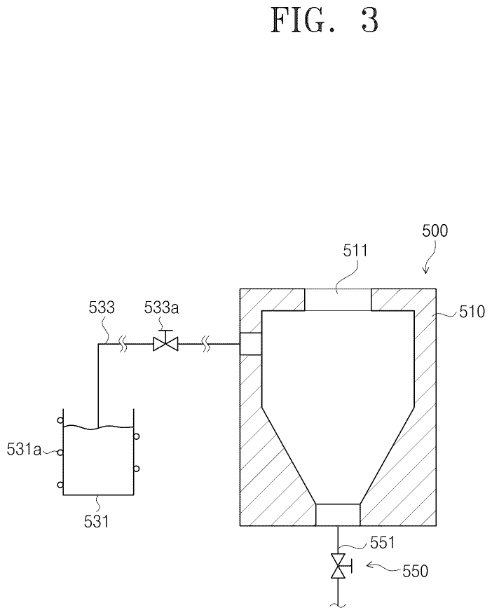

FIG. 3 is a diagram schematically illustrating the homeport of FIG. 2 according to an exemplary embodiment. Referring to FIG. 3, the homeport 500 is installed outside a treatment container 500. The first nozzle 451, the second nozzle 452, and the third nozzle 453 wait in the homeport 500 while the substrate W is not treated. The first nozzle 451, the second nozzle 452, and the third nozzle 453 may be cleaned in the homeport 500. Hereinafter, as an example, a case in which the first nozzle 451 is cleaned in the homeport 500 will be described. The homeport 500 may include a housing 510, a cleaning liquid supply unit 530, and a drainage unit 550.

The housing 510 provides space therein. The housing 510 may be provided in a cylindrical shape. An opening 511 is formed in an upper wall of the housing 510. The first nozzle 451, the second nozzle 452, or the third nozzle 453 may be inserted into the opening 511. A sidewall of the housing 510 may be provided to become thicker as it goes downward. Accordingly, the cleaning liquid may be concentrated in the center of the lower wall of the housing 510. A drainage port 513 is provided in the center of the lower wall of the housing 510. The drainage port 513 may be connected to the drainage unit 550. The cleaning liquid may be discharged to the outside of the homeport 500 through the drainage port 513.

The cleaning liquid supply unit 530 supplies the cleaning liquid to the homeport 500. The cleaning liquid supply unit 530 includes a cleaning liquid supply source 531, a cleaning liquid supply line 533, and a cleaning liquid nozzle 535. The cleaning liquid supply source 531 stores and supplies the cleaning liquid. A heater 531a may be installed in the cleaning liquid supply source 531. The heater 531a may heat the cleaning liquid. According to an example, the cleaning liquid may be the same as the solvent of the first treatment liquid. The solvent may be IPA. The cleaning liquid supply line 533 connects the cleaning liquid supply source 531 to the cleaning liquid nozzle 535. A line heater (not illustrated) may be selectively installed on the cleaning liquid supply line 533. When the line heater is installed, the heater 531a may not be provided to the cleaning liquid supply source 531. The cleaning liquid nozzle 535 is provided at a height corresponding to the surface of the nozzle located in the homeport 500. The cleaning liquid nozzle 535 is inserted into the sidewall of the housing 510. The cleaning liquid nozzle 535 sprays the cleaning liquid toward the nozzle located in the homeport 500.

The drainage unit 550 discharges the cleaning liquid in the housing 510 to the outside. The drainage unit 550 includes a drainage line 551. The drainage line 551 is connected to the drainage port 513 formed in the lower wall of the housing 510. A valve 551a is installed in the drainage line 551. The valve 551a may be an opening/closing valve. The valve 551a may be closed so that the cleaning liquid supplied to the housing 510 is not discharged and is stored in the housing 510.

Hereinafter, a method of treating a substrate will be described. The substrate treating method described below may be performed by the substrate treating apparatus described with reference to FIGS. 1 to 3. Accordingly, hereinafter, the substrate treating method according to an exemplary embodiment will be described by referring to reference numerals denoted in FIGS. 1 to 3. In addition, the substrate treating method described below may be performed by controlling, by a controller, components included in the substrate treating apparatus described above.

Each configuration of the substrate treating apparatus 10 may be controlled by a controller 600. The controller 600 may control the entire operation of the substrate treating apparatus 10. The controller (not illustrated) may include a Central Processing Unit (CPU), a Read Only Memory (ROM), and a Random Access 44-16 Memory (RAM). The CPU executes desired treatment, such as etching treatment, according to various recipes stored in their storage area. In the recipe, device control information for process conditions is stored. Meanwhile, these programs or recipes indicating treatment conditions may be stored in a non-transitory computer-readable medium. The non-transitory computer-readable medium refers to a medium that stores data semi-permanently and is readable by a computer, rather than a medium that stores data for a short moment, such as a register, cache, and memory. Specifically, the above-described various applications or programs may be stored and provided on a non-transitory readable medium, such as a CD, DVD, hard disk, Blu-ray disk, USB, memory card, or ROM.

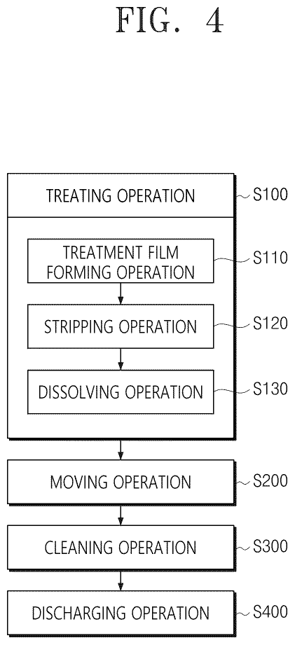

FIG. 4 is a flowchart illustrating a substrate treating method according to an exemplary embodiment of the present invention. Referring to FIG. 4, a substrate treating method according to an exemplary embodiment of the present invention includes a treating operation S100, a moving operation S200, a cleaning operation S300, and a discharging operation S400.

The treating operation S100 is an operation of treating the substrate W with a treatment liquid. The treating operation S100 may be a operation of treating the substrate W to remove foreign substances or the like remaining on the substrate W. According to an example, the treating operation S100 may include a treatment film forming operation S110, a stripping operation S120, and a dissolving operation S130.

In the treatment film forming operation S110, a first treatment liquid is supplied onto the substrate W. The first treatment liquid may be a mixed liquid of a polymer and a solvent. The first treatment liquid is supplied onto the substrate W and then contracts as the solvent volatilizes, thereby forming a solidified treatment film. Foreign substances on the substrate W are captured in the treatment film while the treatment film is formed. When the discharge of the first treatment liquid is terminated, the first suck-back valve 445a suck-backs the first treatment liquid.

In the stripping operation S120, a second treatment liquid is supplied onto the substrate W. The second treatment liquid may be deionized water. After the second treatment liquid is supplied onto the substrate W, the second treatment liquid penetrates into a boundary surface between the treatment film and the substrate W to strip the treatment film from the substrate W.

In the dissolving operation S130, a third treatment liquid is supplied onto the substrate W. The third treatment liquid may be IPA. After the third treatment liquid is supplied onto the substrate W, a residue of the treatment film stripped off on the substrate W is removed from the substrate W.

In the above-described example, the present invention has been described based on the case where the stripping operation S120 and the dissolving operation S130 are sequentially performed as an example. However, the present invention is not limited thereto, and any one of the stripping operation S120 and the dissolving operation S130 may be performed. Also, the stripping operation S120 and the dissolving operation S130 may be performed at the same time. In this case, the second treatment liquid and the third treatment liquid may be discharged through the second nozzle 453 and the third nozzle 455, respectively, or the second treatment liquid and the third treatment liquid may be mixed and discharged only from one of the second nozzle 453 and the third nozzle 455.

After the treating operation S100, the moving operation S200 is performed. Hereinafter, the moving operation S200, the cleaning operation S300, and the discharging operation S400 will be described with respect to the first nozzle 451. It is obvious that the following matters may be applied to the second nozzle 453 and the third nozzle 455 in the same manner.

The moving operation S200 is an operation of moving the first nozzle 451 to the homeport 500. In the moving operation S200, the first nozzle 451 is inserted into the opening 511 formed in the homeport 500. The first nozzle 451 moved to the homeport 500 waits in the homeport 500 until the treating operation S100 is performed again.

The first nozzle 451 that is waiting may be in a state in which the first treatment liquid remains outside and inside the first nozzle 451. For example, the first treatment liquid scattered during the discharge of the first treatment liquid may adhere to the outside of the first nozzle 451, the discharge of the first treatment liquid may be terminated, and the first treatment liquid may remain in a state in which the first treatment liquid is suck-backed inside the first nozzle 451.

When the waiting time is increased, the first treatment liquid remaining outside and inside the first nozzle 451 may be cured. In a state in which the first treatment liquid is cured (hereinafter, referred to as cured product P), it is difficult to clean the cured product P, and when the treating operation S100 is performed again, the cured product P becomes a cause of contamination of the substrate W and needs to be removed.

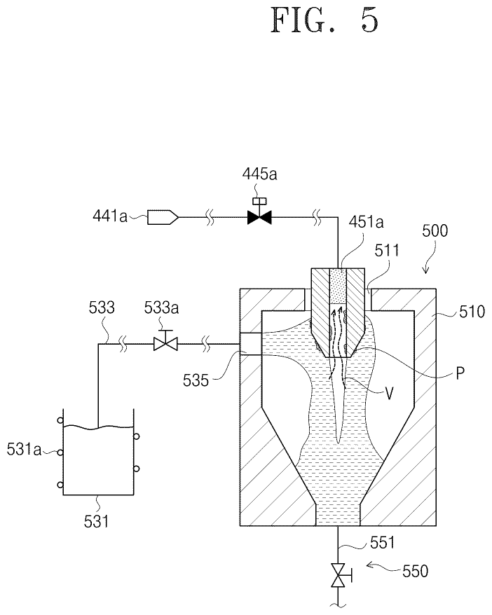

After the moving operation S200, the cleaning operation S300 is performed. FIG. 5 is a diagram schematically illustrating the state in the cleaning operation of FIG. 4. Referring to FIG. 5, the cleaning operation S300 is an operation of cleaning the surface and the inside of the nozzle 535. The surface may be an outer surface of the nozzle 535. The cleaning liquid nozzle 535 sprays the cleaning liquid toward the first nozzle 451. The cleaning liquid may be sprayed until the cured product P is cleaned. According to an example, the cleaning liquid may be sprayed for 1 minute. Also, the cleaning liquid may be heated by the cleaning liquid supply unit 530. According to an example, the cleaning liquid may be heated to 50° C. or higher. The cleaning liquid reacts with the cured product P adhering to the outside of the first nozzle 451 to dissolve the cured product P. In addition, vapor V generated from the sprayed cleaning liquid penetrates into the first nozzle 451 and dissolves the cured product P. Accordingly, the cured product P is in a state that may be easily removed.

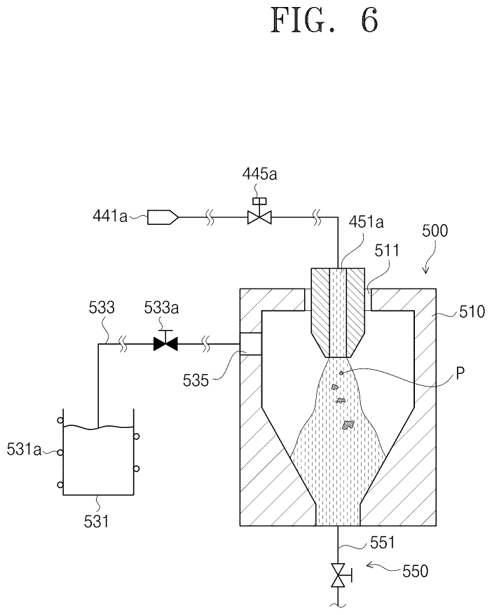

After the cleaning operation S300, the discharging operation S400 is performed. FIG. 6 is a diagram schematically illustrating the discharging operation of FIG. 4 according to an exemplary embodiment. Referring to FIG. 6, the discharging operation S400 is an operation of discharging the first treatment liquid from the first nozzle 451. The cured product P dissolved in the inside of the first nozzle 451 is discharged from the first nozzle 451 together with the first treatment liquid. The discharge medium may be the first treatment liquid. Alternatively, the discharge medium may be supplied from a separate discharge medium supply source 441d. The discharging operation S400 may be performed after a predetermined time has elapsed after the cleaning operation S300.

The cleaning operation S300 and the discharging operation S400 may be repeatedly performed. According to an example, the cleaning operation S300 and the discharging operation S400 may be performed every present time. Also, the cleaning operation S300 and the discharging operation S400 may be performed in a pre-dispensing operation. The pre-dispensing operation is an operation of stabilizing the discharging process by discharging the treatment liquid from the homeport 500 before discharging the treatment liquid onto the substrate W. By performing the cleaning operation S300 and the discharging operation S400 in the pre-dispensing operation, the cleaning of the nozzle and the discharging from the nozzle may be simultaneously performed.

According to the exemplary embodiment of the present invention, by supplying a high-temperature cleaning liquid, vapor V is generated from the cleaning liquid, the vapor V dissolves the cured product P, and discharges the dissolved cured product P together with the first treatment liquid to remove the cured product P from the inside of the first nozzle 451.

In addition, according to the exemplary embodiment of the present invention, the cured product P may be easily cleaned. Accordingly, it is not necessary to form a blocking layer for blocking contact between the treatment liquid inside the nozzle and air to prevent curing of the treatment liquid, and additional processes and configurations required to prevent curing of the treatment liquid may be omitted, and time and cost to prevent curing of the treatment liquid may be saved. In addition, the technical difficulty may be lowered.

In addition, according to the exemplary embodiment of the present invention, when the cleaning operation S300 and the discharging operation S400 are performed before the substrate W is treated by the first treatment liquid, in addition to cleaning the first nozzle 451, the discharge stabilization of the first treatment liquid may be achieved at the same time.

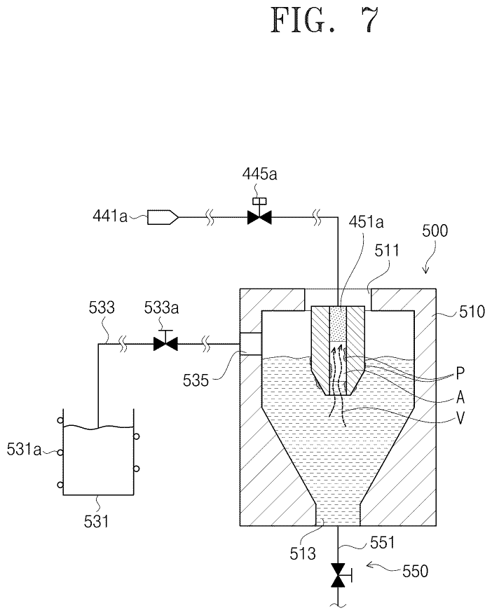

In the above-described example, the present invention has been described based on the case where the first nozzle 451 is cleaned by spraying the cleaning liquid toward the first nozzle 451 as an example. However, the present invention is not limited thereto, and the first nozzle 451 may be cleaned in a bath form as illustrated in FIG. 7. Here, the bath form refers to closing the valve 551a, supplying the cleaning liquid to the housing 510, allowing the cleaning liquid to be accumulated in the housing 510, and then immersing the first nozzle 451 in the cleaning liquid. As the first nozzle 451 is immersed in the cleaning liquid, air existing in the flow path 451a of the first nozzle may naturally form an air layer A, and the vapor V generated from the cleaning liquid may diffuse through the air layer A to dissolve the cured product P.

Furthermore, in the above example, the present invention has been described based on the case where the first nozzle 451, the second nozzle 452, and the third nozzle 453 are supported and moved respectively by the different arms 455 as an example. However, the present invention is not limited thereto, and the first nozzle 451, the second nozzle 452, and the third nozzle 453 may be mounted on the same arm and moved simultaneously. In this case, the homeport 500 may have a plurality of openings into which the first nozzle 451, the second nozzle 452, and the third nozzle 453 are inserted.

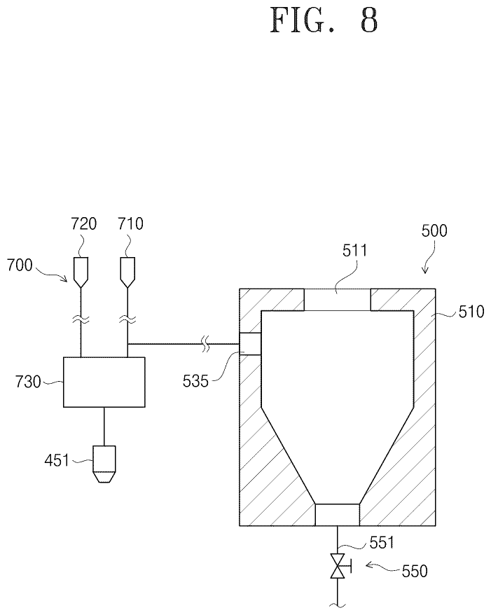

In addition, in the above-described example, the present invention has been described based on the case where the cleaning liquid supply source 531 is separately provided as an example. However, the present invention is not limited thereto. The cleaning liquid supply source 531 may not be provided as illustrated in FIG. 8. As the cleaning liquid, the solvent supplied from a solvent supply source 710 may be used. The solvent supply source 710 is provided to form a treatment liquid. The treatment liquid supply unit 700 may be provided in the form in which the solvent supply source 700 supplies a solvent, a polymer supply source 720 supplies a polymer, and a mixing member 730 mixes the solvent and the polymer to form and supply a treatment liquid.

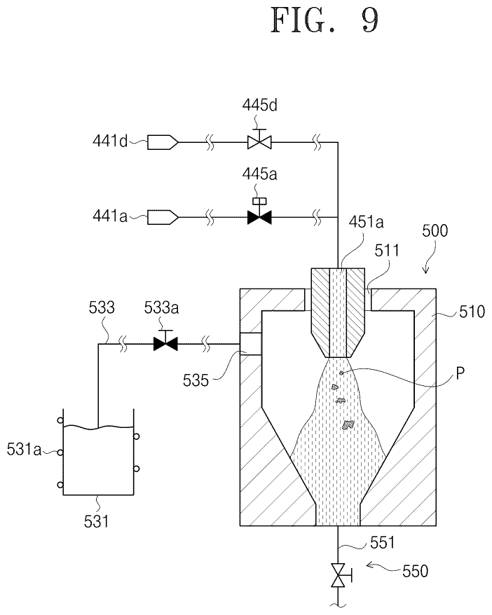

Also, in the above-described example, the present invention has been described based on the case where the first treatment liquid is discharged in the discharging operation S400 has been described as an example. However, the present invention is not limited thereto. As illustrated in FIG. 9, the treatment liquid supply unit 440 may selectively include a discharge medium supply source 441d, and the discharge medium supply source 441d may be connected to a line branched from the first treatment liquid supply line 443a to supply the discharge medium to the first nozzle 451. Accordingly, the discharge medium may be discharged instead of the first treatment liquid in the discharging operation S400. The discharge medium may be liquid or gas. The liquid may be pure water. The gas may be nitrogen or inert gas. The discharge medium may be supplied to the first nozzle 451 in the discharging operation S400. Accordingly, foreign substances, such as the cured product P, therein may be discharged to the outside of the first nozzle 451 while the discharge medium is discharged from the first nozzle.

The foregoing detailed description illustrates the present invention. Further, the above content shows and describes the exemplary embodiment of the present invention, and the present invention may be used in various other combinations, modifications, and environments. That is, the foregoing content may be modified or corrected within the scope of the concept of the invention disclosed in the present specification, the scope equivalent to that of the invention, and/or the scope of the skill or knowledge in the art. The foregoing exemplary embodiment describes the best state for implementing the technical spirit of the present invention, and various changes required in specific application fields and uses of the present invention are possible. Accordingly, the detailed description of the invention above is not intended to limit the invention to the disclosed exemplary embodiment. Further, the accompanying claims should be construed to include other exemplary embodiments as well.

1. A method of treating a substrate, the method comprising:
a treating operation of discharging a treatment liquid onto a substrate through a nozzle and treating the substrate with the treatment liquid;
a moving operation of stopping the discharge of the treatment liquid and moving the nozzle to a homeport where the nozzle waits;
a cleaning operation of cleaning the nozzle with a cleaning liquid in the homeport; and
a discharging operation of discharging the treatment liquid from the nozzle into the homeport.

2. The method of claim 1, wherein the treatment liquid includes a polymer and a solvent, and
in the cleaning operation, the treatment liquid that has been solidified by volatilization of the solvent in the treatment liquid remaining in the nozzle is dissolved in vapor of the cleaning liquid.

3. The method of claim 2, wherein the cleaning operation and the discharging operation are repeatedly performed at preset intervals.

4. The method of claim 3, wherein in the cleaning operation, the cleaning liquid is sprayed toward an outer surface of the nozzle.

5. The method of claim 3, wherein in the cleaning operation, the nozzle is immersed in the cleaning liquid filled in the homeport.

6. The method of claim 2, wherein the cleaning operation includes cleaning the nozzle with the heated cleaning liquid.

7. The method of claim 2, wherein the discharging operation is performed after a set time has elapsed after the cleaning operation.

8. The method of claim 1, wherein the cleaning liquid is the solvent.

9. The method of claim 1, wherein the cleaning liquid is isopropyl alcohol (IPA).

10. The method of claim 1, wherein the discharging operation includes discharging the treatment liquid in the nozzle by discharging a discharge medium.

11. The method of claim 10, wherein the discharge medium is in a liquid or gaseous state.

12. The method of claim 1, wherein the treatment liquid is a first treatment liquid or a second treatment liquid, and
the treating operation includes:
a treatment film forming operation of forming a treatment film by supplying the first treatment liquid to the substrate; and
a removing operation of removing the treatment film from the substrate by supplying the second treatment liquid to the substrate.

13.-17.(canceled)

18. A method of treating a substrate, the method comprising:
a treating operation of discharging a treatment liquid onto a substrate through a nozzle and treating the substrate;
a moving operation of stopping the discharge of the treatment liquid and moving the nozzle to the homeport where the nozzle waits;
a cleaning operation of cleaning the nozzle with a cleaning liquid in the homeport; and
a discharging operation of discharging the discharge medium from the nozzle,
wherein the treatment liquid includes a polymer and a solvent, and
the cleaning liquid is the solvent,
the homeport includes:
a housing providing a space therein;
a cleaning liquid supply unit including a cleaning liquid nozzle that sprays the cleaning liquid toward the nozzle located in the homeport and a heater that heats the cleaning liquid; and
a drainage unit for discharging the cleaning liquid supplied from the cleaning liquid supply unit, and
the cleaning operation includes spraying the heated cleaning liquid toward a surface of the nozzle after the solvent in the treatment liquid remaining in the nozzle volatilizes and the treatment liquid is cured, and
the discharging operation includes dissolving the treatment liquid that has been cured inside the nozzle by vapor generated from the cleaning liquid, and then discharging the discharge medium to remove the discharge medium from an inside of the nozzle.

19. The method of claim 18, wherein the cleaning operation includes filling the homeport with the cleaning liquid and immersing the nozzle in the cleaning liquid.

20. (canceled)
